(19) United States
(12) Patent Application Publication
(10) Pub. No.: US 2010/0302042 A1
(43) Pub. Date: Dec. 2, 2010

(54) SENSOR-BASED INDEPENDENT LIVING ASSISTANT

(76) Inventors: David Barnett, Indianapolis, IN (US); Brian O'Dell, Indianapolis, IN (US); Stephen Sutter, Brownsburg, IN (US)

Correspondence Address: BINGHAM MCHALE LLP, 2700 MARKET TOWER, 10 WEST MARKET STREET, INDIANAPOLIS, IN, 46204-4900, US

(21) Appl. No.: 12/790,259

(22) Filed: May 28, 2010

Related U.S. Application Data
(60) Provisional application No. 61/181,760, filed on May 28, 2009.

(51) Int. Cl. G08B 23/00

(52) U.S. Cl. 340/573.1

(57) ABSTRACT

A computing system helps a person live independently by providing reminders, alerts, and alarms of situations that require the person's attention, notifying another party for emergency or other advice or assistance as necessary. The system receives data from a variety of sensors around the person's environment, developing one or more meaningful composite virtual sensor signals as a function of the data from the physical sensors. Rules operate as a function of the virtual sensor signals to notify the user and/or another party of the situation by way of a smartphone application, cell phone text message, PDA, or other device.

### REFERENCE TO RELATED APPLICATION

This application is a nonprovisional of, and claims priority to, U.S. Provisional Application No. 61/181,760, filed May 28, 2009, pending.

### FIELD

The present invention relates to systems that assist individuals who have mild to moderate intellectual disabilities or other impairments. The architecture is expandable to use a wide variety of sensors, and to process them via a vast array of algorithms to trigger one or more actions.

### BRIEF DESCRIPTION OF THE DRAWINGS

FIG. 1 is a schematic drawing of the major functional components of the system according to one embodiment.

FIG. 2 illustrates a variety of conditions that are monitored by sensors in various embodiments.

FIG. 3 is a flow diagram for the embodiment illustrated in FIG. 1.

FIG. 4 is a screen shot showing a software interface relating to a rule for use in the embodiment illustrated in FIG. 1.

FIG. 5 is a screen shot showing a software interface relating to conditions, sensors, and day/time “sensors” for use in the embodiment illustrated in FIG. 1.

FIG. 6 is a screen shot showing a monitor for a rule for use in the embodiment illustrated in FIG. 1.

FIG. 7 is a screen shot of a prompt test interface for use in the embodiment illustrated in FIG. 1.

FIG. 8 is a screen shot of physical sensors in the embodiment illustrated in FIG. 1.

FIG. 9 is a flow diagram of a sound detection system for use in the embodiment illustrated in FIG. 1.

FIG. 10 is a block diagram of a computer system for use in various embodiments of the disclosed systems and methods.

### DESCRIPTION

For the purpose of promoting an understanding of the principles of the present invention, reference will now be made to the embodiment illustrated in the drawings and specific language will be used to describe the same. It will, nevertheless, be understood that no limitation of the scope of the invention is thereby intended; any alterations and further modifications of the described or illustrated embodiments, and any further applications of the principles of the invention as illustrated therein are contemplated as would normally occur to one skilled in the art to which the invention relates.

Generally, one form of the present invention is a system for monitoring conditions in a person's environment, applying predetermined rules to detect when certain reminder prompts should be given and other actions should be taken, and executing those reminders and actions. This embodiment provides a “person-centered” system that assists an individual, or “user,” with living independently while maintaining the person's dignity and privacy wherever possible.

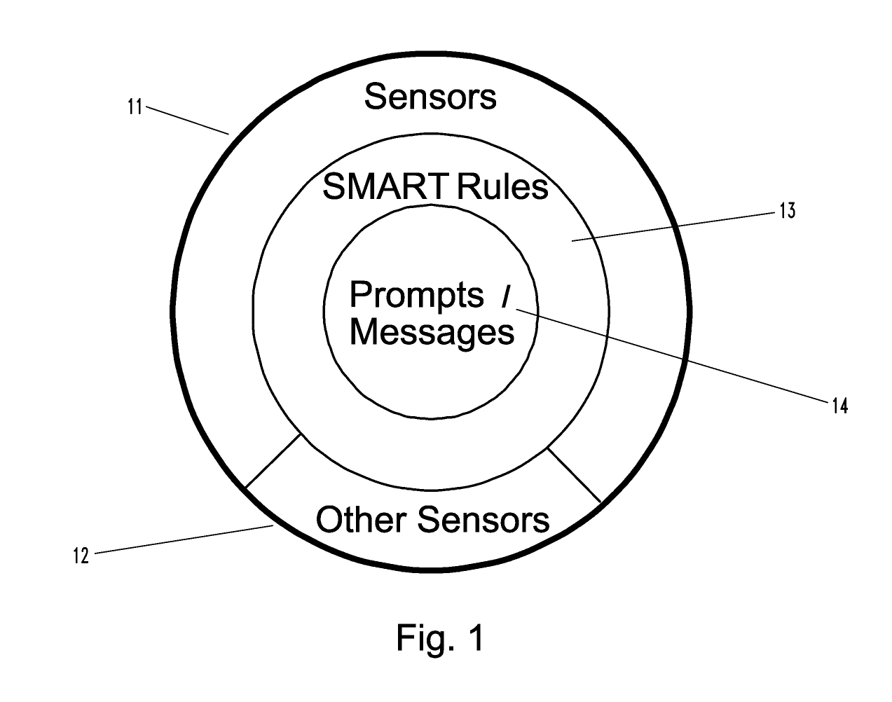

FIG. 1 illustrates an overview of one system embodying the present invention. Several types of sensors 11 (described in more detail below) detect potentially significant conditions in the environment of the primary user and report the data to a centralized server for filtering and processing. Other sensors 12 provided by third parties can be integrated into the system to report additional data to the server. The server uses a customized configuration to process all inputs and determine the significance of each event using SMART Rules layer 13. Important events are passed along to the prompting system. Prompts 14 are sent to the individual to guide them back to appropriate behavior.

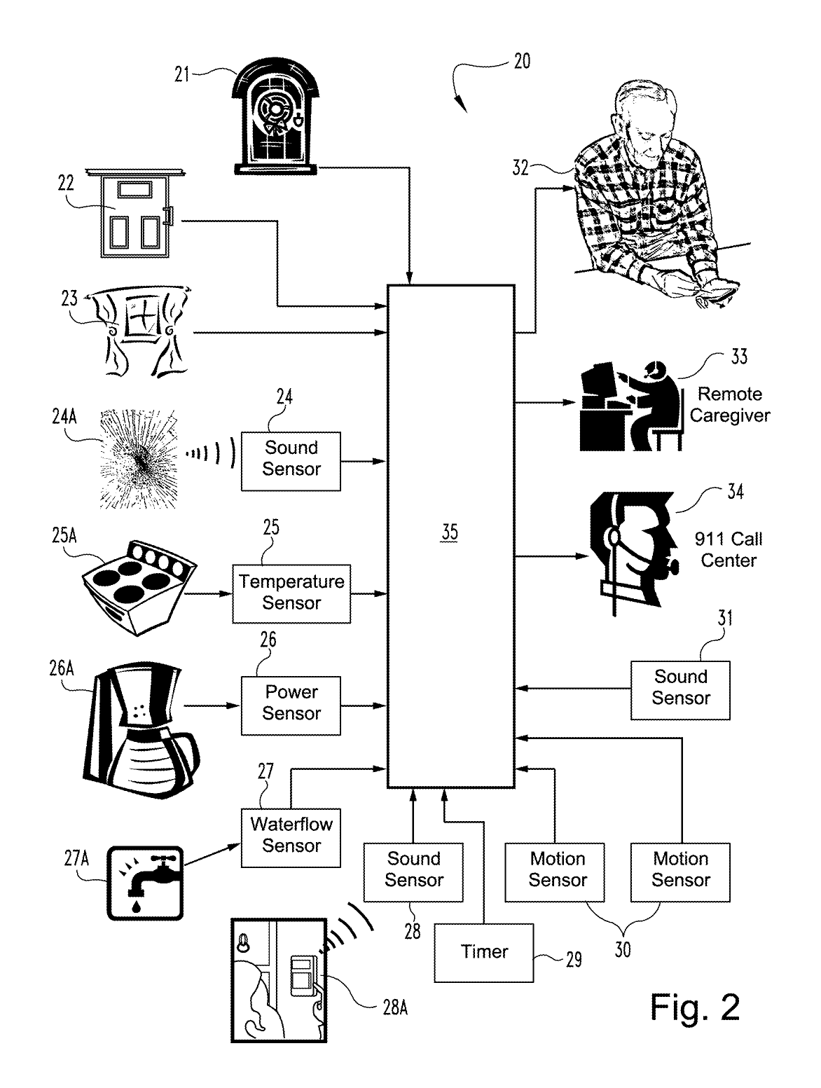

FIG. 2 illustrates system 20, which monitors a variety of conditions in various embodiments. Of course, these sensors and conditions are merely examples; many others will occur to those skilled in the art based on this disclosure. Doors, drawers, and cabinets 21, 22 can be monitored for their state (e.g., open or closed) to give an accurate indication of certain activities of the user. Likewise, the system can monitor the refrigerator door in the same manner to sense food-related activities. If windows 23 are left open, they can be a safety hazard, so the system detects when the window is left open. Danger to the individual from a break-in is detected in this embodiment by detecting the distinctive sound created by the breaking of glass.

An audible alert or sound-related alert, such as the sound of a window breaking, can be detected by sound sensor 24. Activity on the stove 25A is detected in this embodiment using non-contact, infrared temperature sensors 25 that read whether the stove is on without getting messy. An electric power sensor 26 attached to the coffee pot 26A detects current flow from the wall outlet to the appliance, giving some idea when breakfast is being made. Similarly, a water flow sensor 27 is used to monitor the use of a sink 27A, hygiene, food preparation, and medicine regimens.

A sensor 28 listens for the sound of an intercom 28A in use, while an internal time sensor 29 helps track wakeup times and scheduled activities. Motion sensors 30 positioned around the environment give information about activities and the location of individuals, while a dedicated sound sensor 31 can recognize simple sounds like that of a smoke alarm.

Typically, as further discussed herein, computer 35 prompts the user 32 when a problem occurs, and the system 20 gently guides them to the correct behavior. Caregivers and remote personnel are typically not notified of problems that the user can be guided to solve, unless significant problems arise. When the system computer 35 detects a problem that the user cannot handle without assistance, a remote caregiver 33 is notified. The caregiver 33 can then contact the individual directly or take measures to help them solve the problem. If the remote caregiver 33 is unavailable and the situation is urgent, computer 35 contacts an emergency (911) call center 34 to deal with the situation.

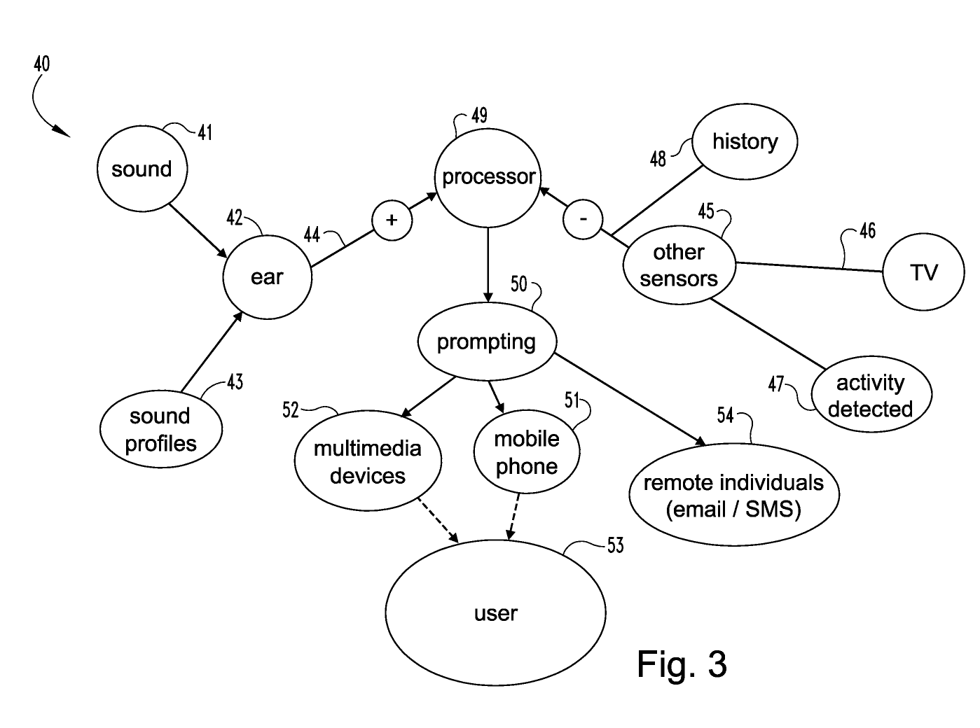

Turning to FIG. 3, the “SoundAlert” system and method 40 will now be described. A sound occurs 41 in the vicinity of an “electronic ear” device, or sound sensor 42. Various relevant sounds might include glass breaking, a dog barking, and emergency sirens, for example. The electronic ear 42 samples the sound at a relatively high frequency and converts it into a compressed sound profile as described below. The profile segments sound into fixed intervals and expresses some simple metrics as well as more sophisticated operations on the sound data. The electronic ear compares the incoming sound profile with the library of predefined sound profiles 43 to determine the most likely match, if any meet a threshold of a match quality metric at all. This comparison process applies relative weights to the different metrics and considers different alignments of the sound profiles with each other.

The electronic ear wirelessly transmits 44 its guess as to what sound it just heard to a central processor, where other factors are used to filter and refine the predicted model of the device's environment. A distributed network of wireless sensors 45 transmits additional information about the environment to help form alternative hypotheses about the sound source or discover factors in the environmental context that might make the sound more or less noteworthy. For example, an electric power sensor 46 (based, for example, on the HAWKEYE 10F current sensor, sold by Veris Industries) attached to the television indicates when the television is active, which gives additional context to explain unusual sounds like gunshots or background music. The motion sensors 47 (based, for example, on the model 49-426, sold by Radio Shack) at key points throughout the environment, and open/closed sensors on doors, drawers, and cabinets help detect activity that would make certain sounds more or less likely. For instance, the system might be configured to treat a dog barking differently if motion has been detected outside the front door.

The system can be configured to treat events differently based on recent history 48, as in the examples just given. After initially recognizing a repeating sound, all subsequent sounds may be considered to have different significance while the individual is attending to the event. The central processor 49 for the system is configured to wait for sound events to be reported, and then filter the events for significance based on the context (see items 45-48, just above). Significant events generate notifications that are passed along to one or more prompting devices 50 according to system settings. In some embodiments, the target or targets of a prompt depend on the specific set of events that triggered the prompt, so that fixed-location prompters will report nearby events where appropriate, and portable prompters such as mobile phones will report other events. In some embodiments, an application running on the user's cellular telephone or smartphone prompts the user using audio, video, prerecorded or synthesized speech, vibration, interactive applications, and the like to guide him or her to appropriate behavior.

Some prompts are associated with an individual rather than a location. In this embodiment, the system transmits those user-specific prompts directly to custom prompting software running on the user's mobile phone, using BLUETOOTH when the phone is within range of the BLUETOOTH transmitter or via SMS messages to special prompting applications running on smartphones 51, such as the Visual Assistant from AbleLink Technologies (when a BLUETOOTH link is not accessible). For events that are bound to a specific location, such as the bathroom or kitchen, initial prompts are targeted to a stationary multimedia device 52 near the area of interest. These devices use a standard WiFi (802.11a/b/g/n) connection and run custom prompting software to display prompts in an intuitive fashion.

Some embodiments of system 20 are designed to provide person-centered prompts, to really help a person live independently instead of replacing a dependence on caregivers with a dependence on the system. Prompts go directly to the user except in the case of emergencies. The system 20 uses gentle reminders and praise to reinforce appropriate activities, and continues to guide the user 53 until the event is appropriately handled. If the problem condition persists after some predefined time, or if the condition is particularly urgent, the system can send email or SMS messages to a remote individual, such as a caregiver or 911 operator 54.

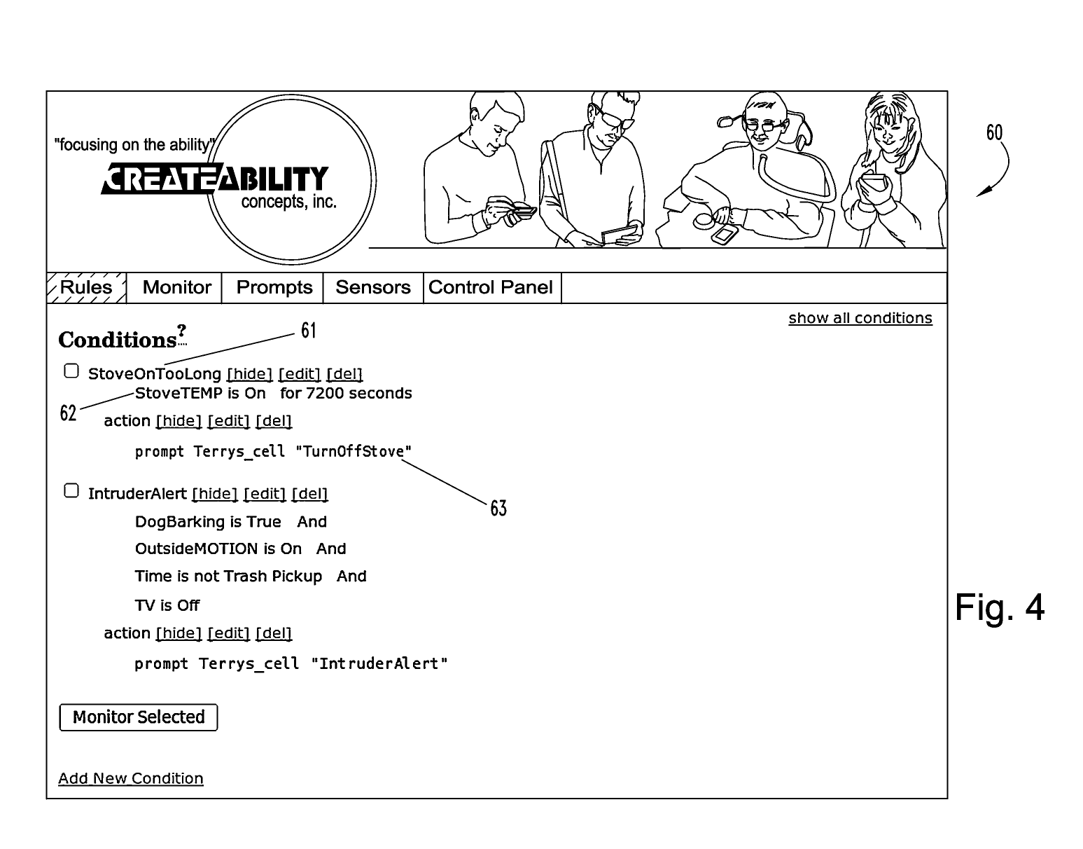

FIG. 4 illustrates a listing 60 of configured conditions 61 on a “Rules” page of an HTML-based interface. Below the title is a description 62 of the characteristic activity pattern that defines the condition. This condition might be based on the state of physical sensors and/or other conditions defined in the system. In some embodiments, users, system monitoring agents, or related vendors apply Boolean and/or symbolic conditions (or “virtual sensor signals”) into new conditions with richer inferential meaning. One or more actions 63 can be associated with each condition. Any associated actions are triggered when the condition criteria are met.

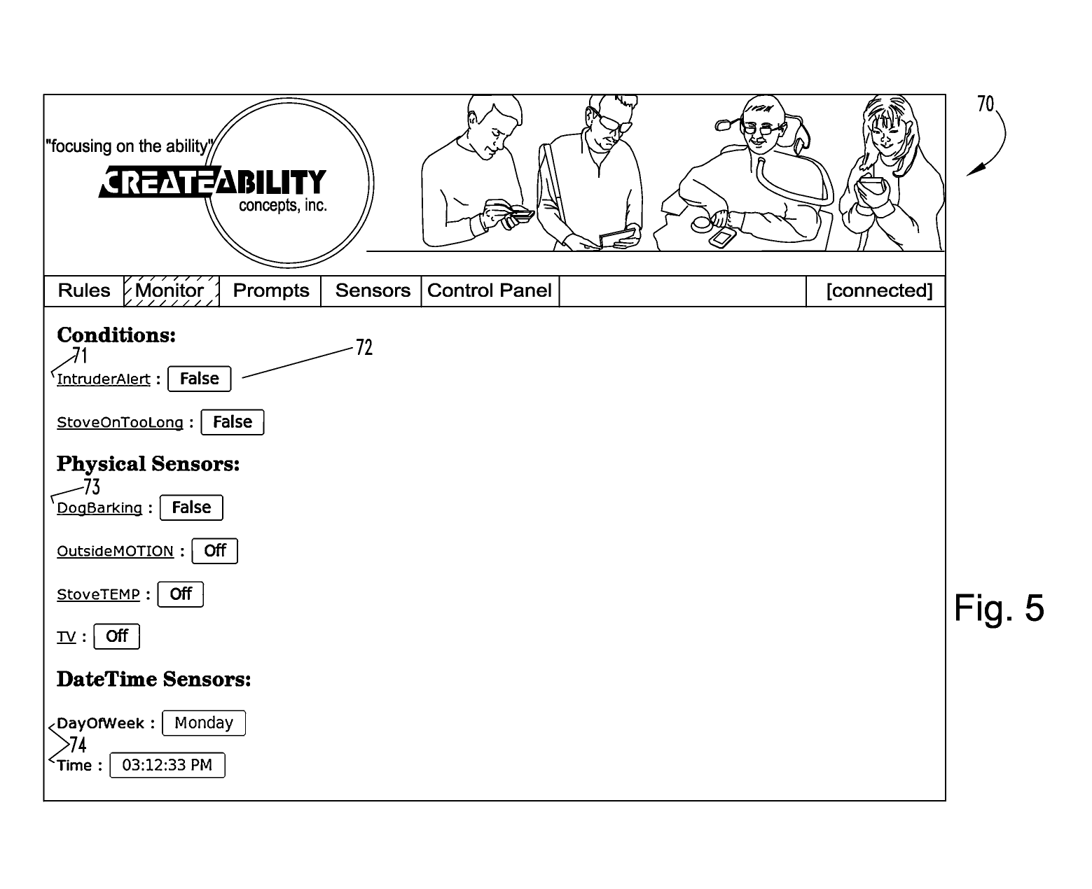

Caregivers, technicians, and users (collectively “operators”) can see each resource and its associated state on the monitor page 70, an example of which is illustrated in FIG. 5. Defined conditions 71 appear in the section at the top. The current status of each resource 72 appears next to the resource name. The operator can manually change the status of some of the resources by clicking on a button next to the resource name. Physical sensors 73 in the environment appear in a separate section. Date and time sensors 74 can trigger events at predetermined times and help detect conditions that should only occur at certain times or on certain days or dates.

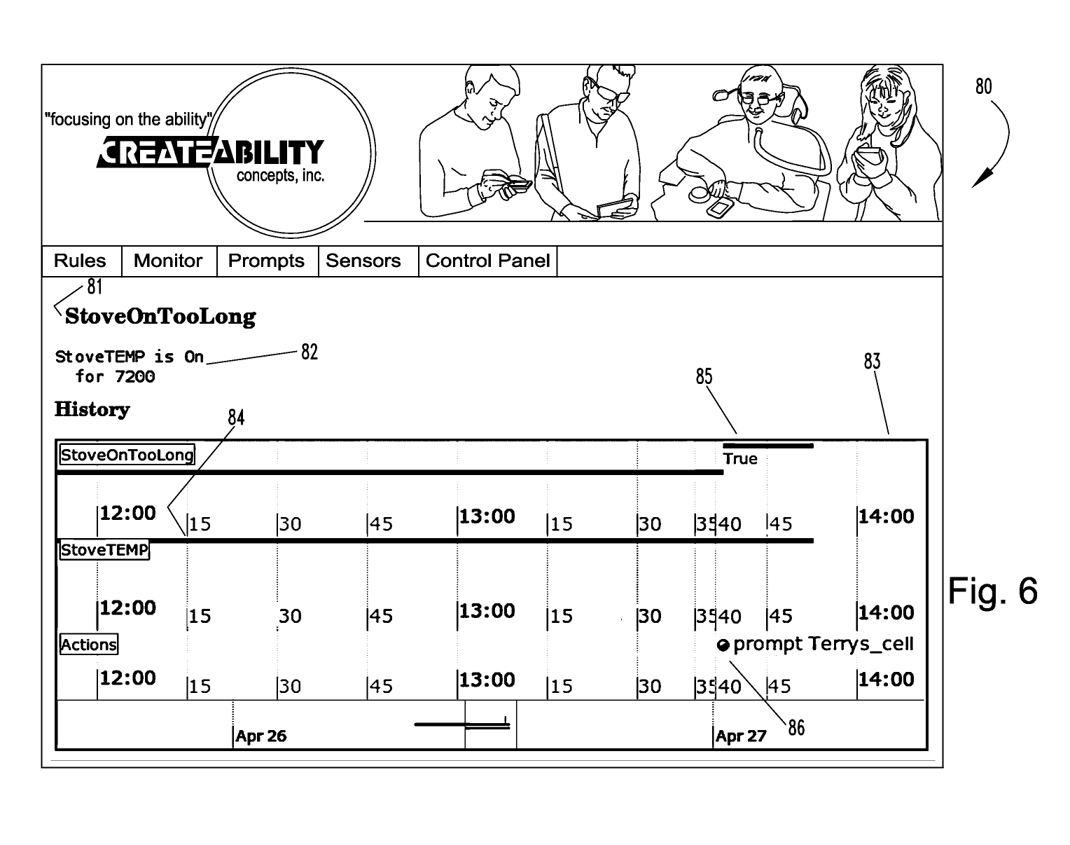

A history page 80 showing a sensor's activity and the names of the associated sensors can be viewed by selecting a sensor name on the monitor page, such as “StoveOnTooLong” 81, as illustrated in FIG. 6. The name of the resource being viewed appears at the top of the page 80. On the history pages 80 for defined conditions 82, the definition appears below the name. Each history page 80 shows a timeline 83 of significant times and the state transitions that occurred at each listed time. In addition to the history for the resource itself, condition history pages 80 in this embodiment show any other resources important for recognizing the condition. In the illustrated example, the system detects the stove turning on and off (as illustrated in graph 84) throughout the day, but it is not turned off after the last time it is turned on. Two hours later, the system recognizes that the stove has been on for the specified length of time, and the condition is activated 85. Associated actions or prompts are triggered at this point 86.

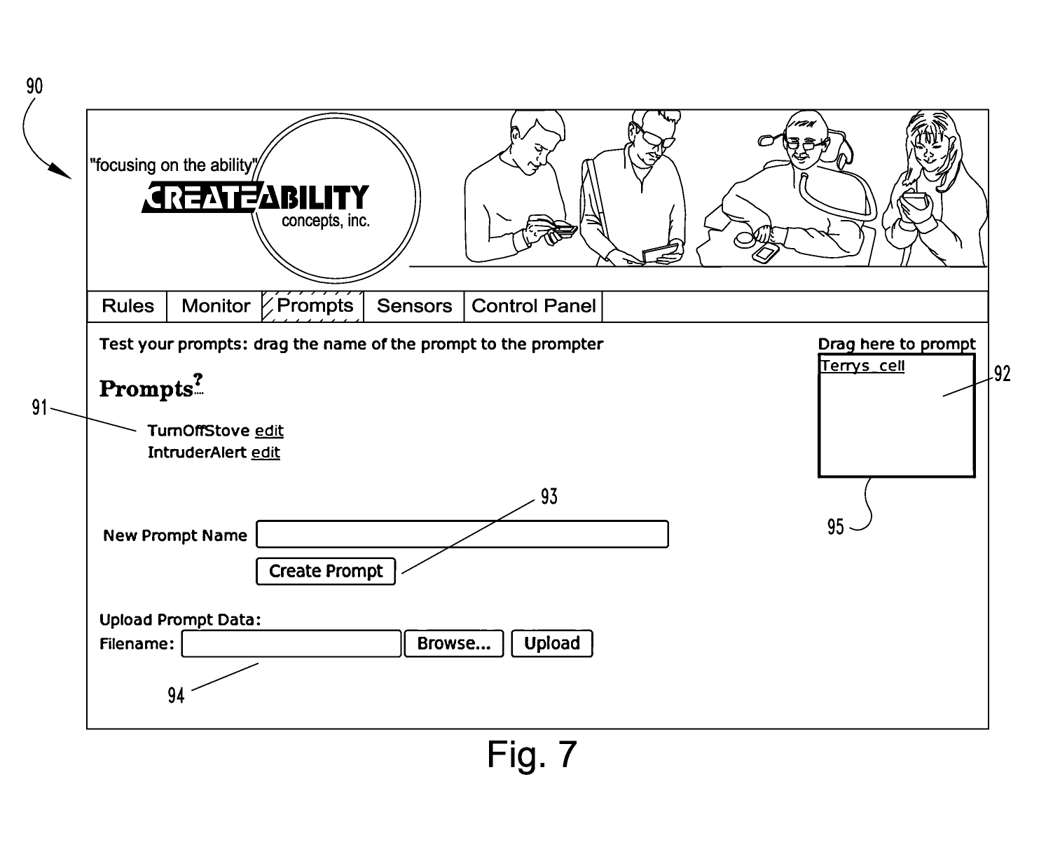

The prompts page 90 illustrated in FIG. 7 shows a list of defined prompts. In this embodiment, each prompt (or “notification”) can contain an image, an audio file, a caption, and a vibration pattern for devices with vibration capabilities. Defined prompting devices appear in device box 95 down the right side of the page 92. A prompt name 91 can be dragged from the prompts list onto box 95 for a prompting device to manually transmit the prompt to the device (e.g., for testing purposes). New prompts can be defined 93 by an operator. The image and audio are selected in this embodiment from a previously uploaded library, and the caption and vibration sequences are added and appear in the list of prompts after they are created. Additional media can be uploaded 94 to the image and audio libraries to be added into prompts.

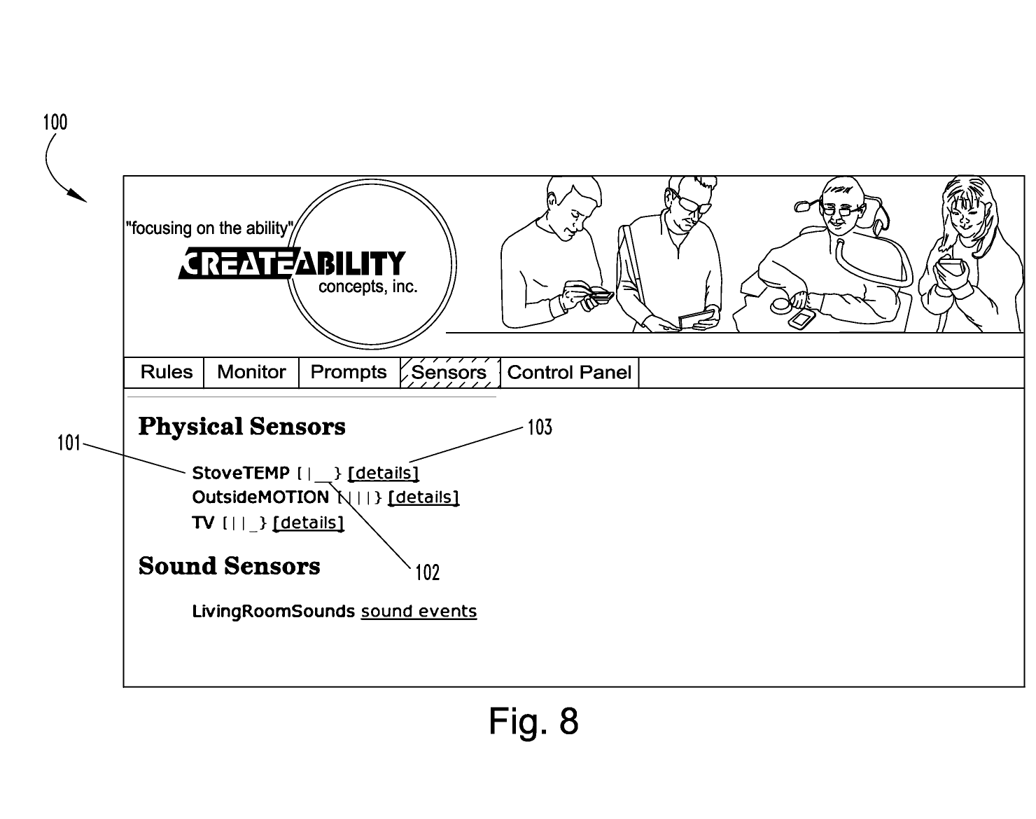

The sensors page 100, illustrated in FIG. 8, lists each defined sensor 101. The current battery level 102 appears next to each sensor to help manage the sensors and prevent battery failure. The details of recent communication activity with the sensor can be viewed by clicking on “details” 103 to help troubleshoot connectivity problems.

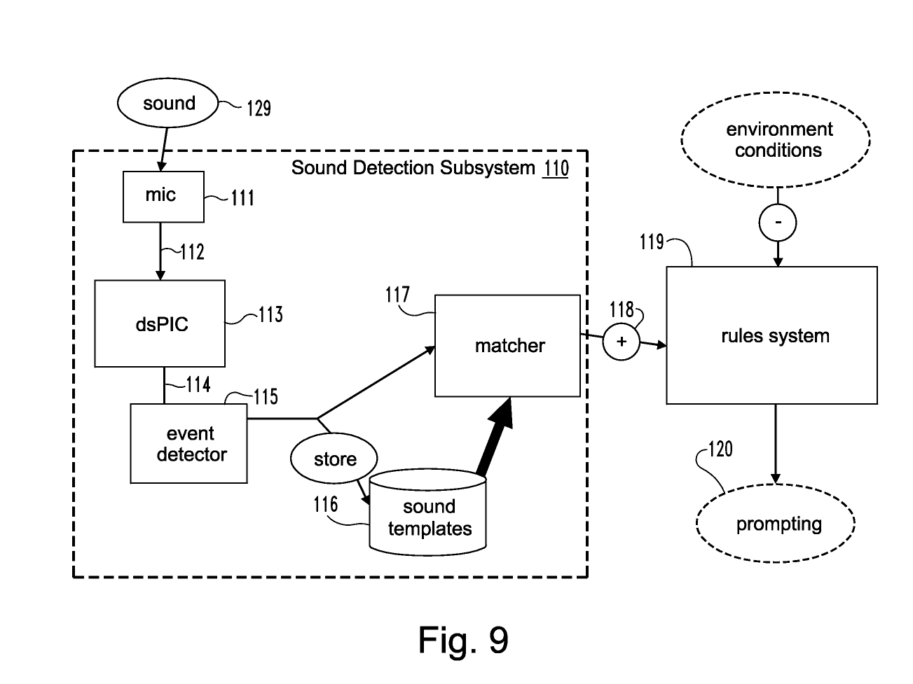

FIG. 9 illustrates additional detail regarding the hardware and software subsystem 110 used to detect and identify specific sounds in various embodiments of this invention. In this example system, a microphone 111 picks up a sound 129 and transmits the analog waveform 112 to a dsPIC device 113 for analysis. The dsPIC device 113 samples the waveform 112 at 12 ksps, collecting a “chunk” of 256 samples at a time to be analyzed as a group.

The dsPIC processes each 256-sample chunk (corresponding in this embodiment to 21.33 ms) of sound samples through each of several algorithms. In this embodiment, these algorithms only analyze patterns within each chunk of samples; all comparisons between different sounds happen at a later stage of processing, and the dsPIC keeps no long-term history of previous sounds. The algorithms used at this stage of this embodiment are:
Zero-Crossings (ZC): a simple count of the number of times the signal crosses the zero level in the chunk.
Time Domain Envelope (TDE): The maximum amplitude of any sample in the chunk.
Frequency Binning (FB): The amplitude of each of the 16 frequency components in the chunk, determined using a basic FFT algorithm.
Linear Predictive Coding (LPC): Seven special coefficients computed by a freely available LPC algorithm, such as the SMD Tools available from Princeton University at http://smdtools.cs.princeton.edu (as of May, 2009), which aims to distinguish human vocal sounds from other types of sound.

The outputs of these algorithms are combined into a “sound sliver” data structure 114 for each chunk of audio data. In this embodiment, this is a 48-byte data structure for each 21.33 ms, comprising one byte of ZC, one byte of TDE, 16×2 bytes FB, and 7×2 bytes of LPC. Each extracted sliver is transmitted continuously over a serial connection to a listening Python program running on a single-board computer. The dsPIC discards the original 256 samples at this stage, and the upstream devices receive only the 48-byte sliver data structure 114.

Inside the Python program, an event detector component 115 analyzes the incoming sound slivers 114 to detect a group of slivers representing a discrete sound event. In this embodiment, the detector watches the TDE metric of each sliver 114 for a pattern of near-silence, then sound above a certain threshold for some duration, then near-silence again for a certain duration. The volume thresholds and durations have no special values and are sometimes tuned for the particular deployment environment. Once a sound event has been recognized, the sound slivers 114 that make up the event are passed on to the matcher 117 (implemented in Python) to compare the incoming sliver 114 with slivers from previously recorded sound templates.

If the Python process is in recording mode, the sound template making up the sound event is assigned a unique identifier and is stored in a library of sound templates 116 that will be compared against each incoming sound event in listening mode. For convenience, multiple templates can be grouped into one “sound profile” to represent different instances of the same sound that the rest of the system should treat identically. The recording mode interface prompts for a profile identifier to associate with each template, then generates a one-byte template identifier within the selected profile so the template itself can be uniquely addressed.

In listening mode, the program compares 117 each incoming sound event against the library of recorded sound templates to detect any similarities. The simple Zero-Crossing metric is used as a first stage to synchronize the event with each template for further comparison. The best synchronization of the time axis is the position with the lowest average difference between Zero-Crossing values (template versus new event) at each sliver. Then, for each template, the program finds the average difference between the template and incoming sound for each metric at each sliver. In this embodiment, a weighted average of each average difference is used to score the algorithm, and the lowest score is considered a match if it is below a certain absolute threshold. Other embodiments use different matching thresholds and techniques. These weights and threshold depend, of course, on the parameters and design of the particular system, and can be determined in each instance by those skilled in the art.

After the matcher program receives a sound event, it sends a message over an 802.11 wireless connection to the rules system using the standard XMLRPC format. The message contains the profile identifier and template identifier of the best-matching sound template, with profile zero being reserved in this embodiment for a sound event with no clear match. When the rules system 119 receives a Sound Match message 118, it checks for the profile identifier in any defined rules (see above), evaluating the profile as a triggered sensor. If the profile identifier is referenced in any rules, and the rule transitions into a True state, then the system executes any associated actions 120 such as prompts (see above).

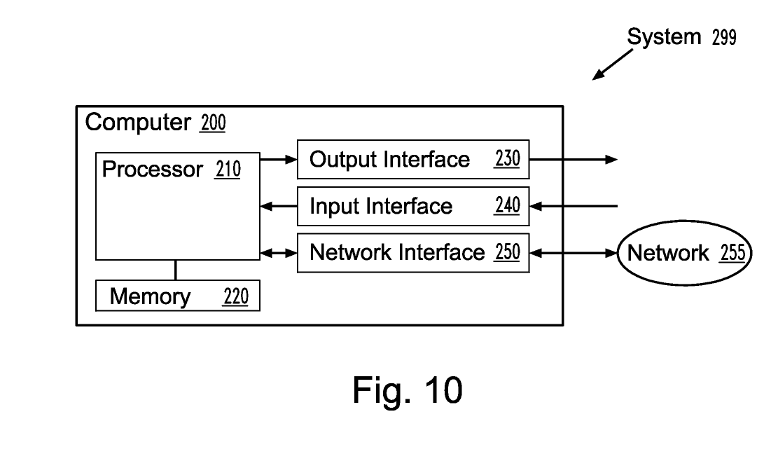

In some embodiments of the system described herein, the computing resources that are applied generally take the form shown in FIG. 10. Computer 200, as this example will generically be referred to, includes processor 210 in communication with memory 220, output interface 230, input interface 240, and network interface 250. Power, ground, clock, and other signals and circuitry are omitted for clarity, but will be understood and easily implemented by those skilled in the art.

With continuing reference to FIG. 10, network interface 250 in this embodiment connects computer 200 to a data network (such as network 255) for communication of data between computer 200 and other devices attached to the network. Input interface(s) 240 manages communication between processor 210 and one or more sensors, push-buttons, UARTs, IR and/or RF receivers or transceivers, decoders, or other devices, as well as traditional keyboard and mouse devices. Output interface(s) 230 provides a video signal to display 260, and may provide signals to one or more additional output devices such as LEDs, LCDs, or audio output devices, local multimedia devices, local notification devices, or a combination of these and other output devices and techniques as will occur to those skilled in the art.

Processor 210 in some embodiments is a microcontroller or general purpose microprocessor that reads its program from memory 220. Processor 210 may be comprised of one or more components configured as a single unit. Alternatively, when of a multi-component form, processor 210 may have one or more components located remotely relative to the others. One or more components of processor 210 may be of the electronic variety including digital circuitry, analog circuitry, or both. In one embodiment, processor 210 is of a conventional, integrated circuit microprocessor arrangement, such as one or more CORE 2 QUAD processors from INTEL Corporation of 2200 Mission College Boulevard, Santa Clara, Calif. 95052, USA, or ATHLON or PHENOM processors from Advanced Micro Devices, One AMD Place, Sunnyvale, Calif. 94088, USA. In alternative embodiments, one or more reduced instruction set computer (RISC) processors, application-specific integrated circuits (ASICs), general-purpose microprocessors, programmable logic arrays, or other devices may be used alone or in combination as will occur to those skilled in the art.

Likewise, memory 220 in various embodiments includes one or more types such as solid-state electronic memory, magnetic memory, or optical memory, just to name a few. By way of non-limiting example, memory 220 can include solid-state electronic Random Access Memory (RAM), Sequentially Accessible Memory (SAM) (such as the First-In, First-Out (FIFO) variety or the Last-In First-Out (LIFO) variety), Programmable Read-Only Memory (PROM), Electrically Programmable Read-Only Memory (EPROM), or Electrically Erasable Programmable Read-Only Memory (EEPROM); an optical disc memory (such as a recordable, rewritable, or read-only DVD or CD-ROM); a magnetically encoded hard drive, floppy disk, tape, or cartridge medium; or a plurality and/or combination of these memory types. Also, memory 220 is volatile, nonvolatile, or a hybrid combination of volatile and nonvolatile varieties.

Computer programs implementing the methods described herein will commonly be distributed either on a physical distribution medium such as CD-ROM, or via a network distribution medium such as an internet protocol or token ring network, using other media, or through some combination of such distribution media. From there, they will often be copied to a hard disk or a similar intermediate storage medium. When the programs are to be run, they are loaded either from their distribution medium or their intermediate storage medium into the execution memory of the computer, configuring the computer to act in accordance with the method described herein. All of these operations are well known to those skilled in the art of computer systems.

The term “computer-readable medium” encompasses distribution media, intermediate storage media, execution memory of a computer, and any other medium or device capable of storing for later reading by a computer a computer program implementing a method.

Any publications, prior applications, and other documents cited herein are hereby incorporated by reference in their entirety as if each had been individually incorporated by reference and fully set forth. While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A method for facilitating independent living of a user, the method operating on a digital computer and comprising:
aggregating data from a plurality of sensors in the user's environment;
processing the data to develop a set of one or more virtual sensor signals; and
by executing rules that operate as a function of the virtual sensor signals, sending a notification to a person programmatically selected from a recipient set consisting of the user and other parties.

2. The method of claim 1, wherein the notification is sent via a device programmatically selected from a plurality of devices.

3. The method of claim 2, wherein the plurality of devices comprises a cellular telephone.

4. The method of claim 2, wherein the plurality of devices comprises a personal digital assistant.

5. The method of claim 1, further comprising displaying an interface operable to change the rules.

6. The method of claim 1, further comprising displaying an interface operable to define a new virtual signal, in the set of virtual signals, as a function of the sensor data.

7. The method of claim 1, wherein the sending step comprises:
first notifying the user of the condition; and
if the condition is not corrected within a period of time after the user is notified, further notifying a caregiver of the condition.

8. A computer system comprising a processor and a memory in communication with the processor, the memory storing programming instructions executable by the processor to perform the method of claim 1.

9. An article of manufacture, comprising a computer-readable medium storing programming instructions executable by the processor to implement the method of claim 1.

10. A method for facilitating independent living of a user, the method operating on a digital computer and comprising:
receiving audio data from one or more sound sensors in the user's environment;
processing the audio data to identify one or more sounds from among a collection of known types of sounds; and
by executing rules that operate as a function of the identified sounds, sending a notification to a person programmatically selected from a recipient set consisting of the user and other parties.

11. The method of claim 10, wherein the processing comprises:
calculating predetermined characteristics of the audio data;
comparing the calculated characteristics with at least one sound template that comprises a collection of characteristics of a particular type of sound; and
based on the result of the comparison, identifying the audio data as coming from the particular type of sound.

12. The method of claim 11, wherein:
the at least one sound template comprises a library of at least two sound templates, each associated with a type of sound; and
the identifying includes programmatically selecting one of the sound templates from the library as a best fit to the calculated characteristics of the audio data, and identifying the audio data as coming from the particular type of sound associated with that selected sound template.

13. The method of claim 10, wherein the processing comprises ignoring sound data that fails to exceed a volume threshold.

14. A computer system comprising a processor and a memory in communication with the processor, the memory storing programming instructions executable by the processor to perform the method of claim 10.

15. An article of manufacture, comprising a computer-readable medium storing programming instructions executable by the digital computer to implement the method of claim 10.

16. A method for facilitating independent living of a user, the method operating on a digital computer and comprising:
aggregating data from a plurality of sensors in the user's home environment;
based on rules that operate as a function of the data, identifying a situation in the user's home environment that threatens harm to the user or property;
initiating a notification to the user regarding the situation; and
if, by applying additional rules to further data from one or more of the plurality of sensors, it is determined that the situation remains, then initiating a further notification to a remote party regarding the situation.

17. The method of claim 16, wherein the remote party is a remote caregiver.

18. The method of claim 16, wherein the remote party is an emergency responder.

19. The method of claim 16, wherein the digital computer is situated in the user's home.

20. A computer system comprising a processor and a memory in communication with the processor, the memory storing programming instructions executable by the processor to perform the method of claim 16.

21. An article of manufacture, comprising a computer-readable medium storing programming instructions executable by the digital computer to implement the method of claim 16.
